(19) United States
(12) Patent Application Publication
(10) Pub. No.: US 2007/0219909 A1
(43) Pub. Date: Sep. 20, 2007

(54) System and method for automatically updating timed DRM keys

(76) Inventors: Robert Hardacker, Escondido, CA (US); Christopher Jensen Read, San Diego, CA (US)

Correspondence Address: ROGITZ & ASSOCIATES, 750 B STREET, SUITE 3120, SAN DIEGO, CA, 92101, US

(21) Appl. No.: 11/403,753

(22) Filed: Apr. 13, 2006

Related U.S. Application Data
(60) Provisional application No. 60/782,590, filed on Mar. 14, 2006.

(51) Int. Cl. H04L 9/00

(52) U.S. Cl. 705/51

(57) ABSTRACT

A system and method for renewing the ability of a component to play digital content. A timer is established, and before the elapse of the timer the component is engaged with a battery charging cradle. By virtue of the component being engaged with the cradle, the timer is reset.

### RELATED APPLICATION

This application claims priority from U.S. provisional application Ser. No. 60/782,590, filed Mar. 14, 2006.

### I. FIELD OF THE INVENTION

The present invention relates generally to automatically updating digital rights management (DRM) information, such as encryption keys, that are timed to expire.

### II. BACKGROUND OF THE INVENTION

Wireless home entertainment systems have been provided that can include a set-top box media server that communicates over a wireless system such as an 802.11 system with various components in the home, e.g., TVs, laptop computers, and custom display devices. Wired systems such as power line communication (PLC) systems have also been introduced. Regardless of the particular type of network, portable devices for listening to, viewing, or otherwise enjoying valuable content are becoming ever more important, along with the concomitant necessity of managing rights in the content.

Indeed, the control of the distribution and usage of content has introduced the concept of digital rights management (DRM), which typically entails the timed usage of content. By strengthening restrictions and increasing the transparency of the restrictions, fair use of content that both buyer and seller agree on results. For instance, as recognized herein original content may be permitted to be copied for a limited time, so that when a user purchases the content it can be viewed on various players in the user's home network. The present invention understands that it is desirable that copies be set to expire after a limited time, but with the expiring temporary licenses extendable under certain conditions, so that content, once purchased, is not permanently limited to being played on only a single player in a home network.

### SUMMARY OF THE INVENTION

A home entertainment system includes a server, a component possessing a copy of managed “original” content with the copy being associated with an expiration time, and a charging cradle configured to engage the component to charge its battery. The expiration time can be reset by virtue of the component being engaged with the cradle.

In a non-limiting implementation the expiration time is based on an expected length of time between battery chargings for the component. If desired, the expiration time can be reset only if DRM information associated with the “original” content is recognized at an appropriate or expected location in the system, and if it is not, the expiration time is not reset when the component is engaged with the cradle. The component may be detected to be in its cradle by the server, or the component or its cradle may seek out the server when the component is being recharged to report status to the server. To this end, the cradle may include a communication system to facilitate resetting of the expiration time.

In another aspect, a method for renewing the ability of a component to play digital content includes establishing a timer, and before the elapse of the timer, engaging the component with a battery charging cradle. The method further includes, by virtue of the component being engaged with the cradle, resetting the timer.

In still another aspect, a system for renewing digital rights associated with a copy of original content includes a battery powered component and a charging cradle with which the component can be engaged to both charge a battery in the component and to renew the digital rights.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention;

FIG. 2 is a flow chart of the present logic, it being understood that any appropriate component or components in the system of FIG. 1 may execute the logic.

### DETAILED DESCRIPTION OF THE PREFERRED EMBODIMENTS

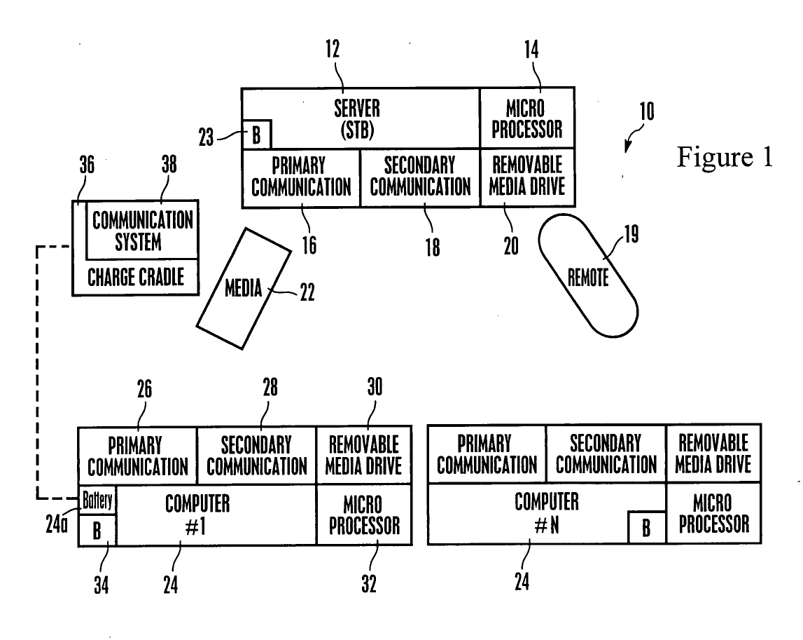

Referring initially to FIG. 1, a non-limiting home entertainment system is shown, generally designated 10, that includes a server 12 having a processor or processors 14 that may be housed in a set-top box or personal video recorder (PVR) or other component. The server 12 can receive televised content from an antenna, satellite dish, cable, etc. for display of the content on one or more of the below-described system components. The processor 14 alternatively can be incorporated into the housing of a TV to function in accordance with the disclosure herein, or it can be implemented by plural processors (e.g., one in a PVR and one in the TV or set-top box) acting in concert with each other. Or, the server 12 may be implemented by a computer such as a PC or laptop.

In the preferred non-limiting embodiment shown, the processors described herein may access one or more software or hardware elements to undertake the present logic. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

The non-limiting server 12 shown in FIG. 1 may if desired includes a primary wireless communication system 16, such as an 802.11 communication system, or a primary wired communication system such as a power line communication (PLC) network, and if desired a secondary communication system 18 that is out-of-band with the primary system 16. Without limitation, the optional secondary communication system 18 may be a line-of-sight infrared (IR) system, in which case a television or other IR remote control device 19 may be provided. Or, the secondary communication system 18 may be a near-field communication system having an effective range of communication of, e.g., twenty five feet or less. A near-field system may be implemented by a near field “Smart Card”, and may have a frequency of between five and fifteen megaHertz (5 MHz- 15 MHz) and use Amplitude Shift Keying (ASK). As understood herein, smart-card like functionality for proximal communication can be incorporated into mobile telephones or other devices. Yet again, the secondary communication system 18 may use personal area network (PAN) principles known in the art to transfer information between the server 12 and the components discussed through a person's body below when the person touches an electrode that is part of each component's secondary communication system. In such an implementation the carrier frequency may be under one megaHertz (<1 MHz), and on-off shift keying may be used for modulation.

In addition, the server 12 can have a removable media drive 20 with which a removable media 22, such as a Sony Memory Stick®, floppy diskette, other flash memory, universal serial bus (USB) dongles, or other removable memory media can be detachably engaged to exchange information between the server 12 and the components discussed below. One or more buttons 23 can also be provided on the server 12.

FIG. 1 shows that the system 10 includes one or more components 24, each of which may have a respective battery 24a and each of which may communicate with the primary communication system 16 of the server 12 using a respective primary communication system 26. The components 24 may include, e.g., televisions, laptop computers, audio players, projectors, custom display devices, wireless telephones, portable music players, and so on. The primary communication systems are used to communicate, e.g., audio/video data streams from the server 12 to the components 24 for presentation on displays associated with the components 24. Other data may also be transferred over the primary communication systems.

Each component 24 may also optionally include a respective secondary communication system 28 that communicates with the secondary communication system 18 of the server 12. Also, each component 24 may include a respective removable media drive 30, and be controlled by a respective processor 32. One or more buttons 34 may be provided on each component 24.

Because a component 24 may be portable, it may include a battery 24a that is rechargeable by means of a charging cradle or base 36. In the non-limiting embodiment shown a charging cradle 36 may include a communication system 38, e.g., a PLC system that can communicate with other components in the network. Or, the communication system 38 may be a wired or wireless system such as Bluetooth, universal serial bus (USB), i.LINK, etc. In any case, it will readily be appreciated that a component 24 can be physically placed on an associated charging cradle 36 to recharge batteries in accordance with portable electronic device recharging principles known in the art.

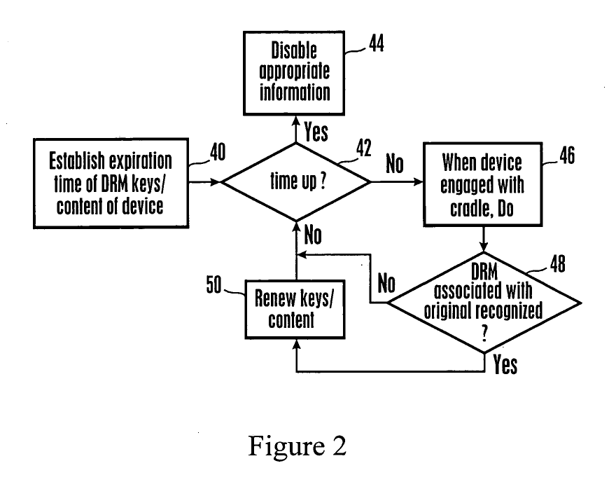

Now referring to FIG. 2, the general logic for renewing DRM information at a particular component 24 is shown. FIG. 2 makes the following assumptions. First, it is assumed that an “original” of the content can be shown to exist (or not) in the system shown in FIG. 1 either as a purchased disk, or as a legitimately downloaded file in a non-volatile memory such as a hard disk drive, Memory Stick®, burned disk, etc. It is also assumed that copies of the content are expected to be made legitimately available on other components 24 for fair use, such as on, e.g., portable music players, wireless telephones, or even in vehicles associated with the user of the system. It is further assumed that timers can be associated with copies of content allowing temporally limited usage, after the expiration of which the content is rendered inaccessible by, e.g., changing the encryption key values needed to decrypt the content, or by re-encrypting the content using new keys, or by other appropriate means. FIG. 2 also assumes that in non-limiting embodiments a timer may be reset by means of proving ownership of the “original” content. By “reset” is meant that value or indicated time remaining of the timer is increased, typically by resetting to the value determined at block 40.

Commencing at block 40, for each component 24 that possesses copies of managed “original” content, an expiration time is established for its DRM keys. Equivalently, the managed content itself may be given an expiration time. The expiration time may be based on the expected length of time between battery chargings for the component.

Proceeding to decision diamond 42, for the particular component it is determined whether its DRM timer is up. If so, appropriate information, e.g., the content itself, or the DRM keys, are disabled at block 44. While FIG. 2 is cast in flow chart format, it is to be understood that the logic essentially can be implemented as a state machine that changes state to move to block 44 upon elapse of the DRM timer, absent execution of the following logic.

If the DRM timer is not expired, the logic moves to block 46 when the component 24 is placed in its cradle 36 for recharging. At decision diamond 48 it is determined whether DRM associated with the “original” content discussed above is recognized at an appropriate or expected location in the system. If not, the logic reverts to decision diamond 42, but if DRM associated with the “original” content discussed above is recognized at an appropriate or expected location in the system, the DRM keys associated with the copy of the original and/or the content of the copy are renewed at block 50. This logic can be undertaken for the component 24 as a whole or for every individual piece of content possessed by the component. Because the cradle 36 is plugged into the power line, communication necessary to execute the logic may be undertaken using PLC principles.

In some implementations, the portable component 24 can be detected to be in its cradle 36 by the server 12. Or, the portable component 24/associated cradle 36 can seek out the server 12 when the component is being recharged to report status to the server 12. The cradle 36 may not possess a communication system, in which case the network connection to support the above logic could be between the component 24 and server 12 directly. As mentioned above, any of the secondary communication systems may also be used for this purpose.

While the particular SYSTEM AND METHOD FOR AUTOMATICALLY UPDATING TIMED DRM KEYS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

What is claimed is:

1. A home entertainment system, comprising:
at least one server;
at least one component possessing at least one copy of managed “original” content, the copy being associated with an expiration time; and
at least one recharging cradle configured to engage the component to recharge a battery thereof, wherein the expiration time can be reset by virtue of the component being engaged with the cradle.

2. The system of claim 1, wherein the expiration time is based on an expected length of time between battery chargings for the component.

3. The system of claim 1, wherein the expiration time is reset only if DRM information associated with the “original” content is recognized at an appropriate or expected location in the system, and if not, the expiration time is not reset when the component is engaged with the cradle.

4. The system of claim 1, wherein the component is detected to be in its cradle by the server.

5. The system of claim 1, wherein at least one of the component, or the cradle, seeks out the server when the component is being recharged to report status to the server.

6. The system of claim 1, wherein the cradle includes a communication system to facilitate resetting of the expiration time.

7. A method for renewing the ability of a component to play digital content, comprising:
establishing a timer;
before the elapse of the timer, engaging the component with a battery charging cradle; and
at least in part by virtue of the component being engaged with the cradle, resetting the timer.

8. The method of claim 7, wherein the timer defines an expiration time based on an expected length of time between battery chargings for the component.

9. The method of claim 7, wherein the timer is reset only if DRM information associated with original content is recognized at an appropriate or expected location, and if not, the timer is not reset when the component is engaged with the cradle.

10. The method of claim 7, wherein the component is detected to be in its cradle by a server.

11. The method of claim 7, wherein at least one of the component, or the cradle, seeks out a server when the component is being recharged to report status to the server as part of the resetting act.

12. The method of claim 7, wherein the cradle includes a communication system to facilitate the resetting act.

13. A system for renewing digital rights associated with a copy of original content, comprising:
at least one battery powered component; and
at least one charging cradle with which the component can be engaged to both charge a battery in the component and to renew the digital rights.

14. The system of claim 13, comprising means for renewing the digital rights only if information associated with the original content is recognized at an appropriate or expected location.

15. The system of claim 14, comprising means for communicating within the cradle.

16. The system of claim 14, wherein the copy is associated with a timer defining an expiration time based on an expected length of time between battery chargings for the component.

17. The system of claim 14, wherein the component is detected to be in its cradle by a server.

18. The system of claim 14, wherein at least one of the component, or the cradle, includes means for seeking out a server when the component is being recharged to report status to the server.
